(19) United States
(12) Patent Application Publication
(10) Pub. No.: US 2026/0120428 A1
(43) Pub. Date: Apr. 30, 2026

(54) OBSERVATION DEVICE AND OBSERVATION METHOD

(71) Applicant: Mitsubishi Electric Corporation, Tokyo (JP)

(72) Inventor: Motofumi ARII, Tokyo (JP)

(73) Assignee: Mitsubishi Electric Corporation, Tokyo (JP)

(21) Appl. No.: 19/431,653

(22) Filed: Dec. 23, 2025

Related U.S. Application Data
(63) Continuation of application No. PCT/JP2023/028500, filed on Aug. 4, 2023.

(51) Int. Cl. G06V 10/75; G06V 10/74

(52) U.S. Cl. CPC G06V 10/751; G06V 10/761

(57) ABSTRACT

An observation method includes: acquiring N (N represents an integer equal to or more than two) threshold sets, which are different from each other, as threshold sets each including thresholds related to at least one type of observation component included in both of a first observation image that is obtained by capturing an observation target region and a second observation image that is obtained by capturing the observation target region at a time different from a time of the first observation image; calculating differences between the observation components included in the first observation image and the observation components included in the second observation image, respectively; performing comparison of the differences of the observation components, and the thresholds included in the threshold sets and respectively related to the observation components; and selecting a certain threshold set from the N threshold sets on a basis of a result of the comparison.

### CROSS REFERENCE TO RELATED APPLICATION

This application is a Continuation of PCT International Application No. PCT/JP2023/028500, filed on Aug. 4, 2023, which is hereby expressly incorporated by reference into the present application.

### TECHNICAL FIELD

The present disclosure relates to an observation device and an observation method.

### BACKGROUND ART

There is an observation device that calculates a difference between a plurality of observation images obtained by capturing an observation target region at respectively different times, compares the difference with a threshold, and detects a change in the observation target region on the basis of a comparison result of the difference with the threshold.

As such an observation device, for example, Patent Literature 1 discloses an observation device including a comparison unit that includes threshold sets each including thresholds related to one or more types of observation components included in an observation image, and compares each of the observation components and the threshold related to each of the observation components.

### CITATION LIST

### Patent Literature

Patent Literature 1: JP 2003-281664 A

### SUMMARY OF INVENTION

### Technical Problem

The observation device disclosed in Patent Literature 1 includes only one threshold set included in the comparison unit. Hence, there is a case where the thresholds related to the observation components included in the threshold set are not values that are suitable for comparison with the difference. In such a case, there has been a problem that detection accuracy of a change in an observation target region deteriorates.

The present disclosure has been made to solve the above problem, and an object of the present disclosure is to provide an observation device that can increase detection accuracy of a change in an observation target region compared to the observation device disclosed in Patent Literature 1.

### Solution to Problem

An observation device according to the present disclosure includes processing circuitry to acquire N (N represents an integer equal to or more than two) threshold sets, which are different from each other, as threshold sets each including thresholds related to at least one type of observation component included in both of a first observation image that is obtained by capturing an observation target region and a second observation image that is obtained by capturing the observation target region at a time different from a time of the first observation image, to calculate differences between the observation components included in the first observation image and the observation components included in the second observation image, respectively, to perform, respectively, comparison of the differences of the observation components, and the thresholds included in the threshold sets and respectively related to the observation components and to select a certain threshold set from the N threshold sets on a basis of a result of the comparison.

### Advantageous Effects of Invention

According to the present disclosure, it is possible to increase detection accuracy of a change in an observation target region compared to the observation device disclosed in Patent Literature 1.

### BRIEF DESCRIPTION OF DRAWINGS

FIG. 1 is a configuration diagram illustrating an observation device according to Embodiment 1.

FIG. 2 is a hardware configuration diagram illustrating hardware of the observation device according to Embodiment 1.

FIG. 3 is a hardware configuration diagram of a computer in a case where the observation device is implemented by software, firmware, or the like.

FIG. 4 is a flowchart illustrating an observation method that is a processing procedure performed by the observation device.

FIG. 5 is an explanatory view illustrating a first observation image G₁ and an observation target image G₂, m.

FIG. 6 is an explanatory view illustrating an example of a weight coefficient W_{d}^{t} (t_{d}^{u}) that changes as time passes.

FIG. 7 is an explanatory view illustrating an example of a region for which a degree of importance has been set by a user.

FIG. 8 is an explanatory view illustrating an example of local information indicating whether or not an abnormality occurs in an observation target region.

FIG. 9 is an explanatory view obtained by overlaying FIGS. 7 and 8.

FIG. 10 is an explanatory view illustrating N threshold sets S¹ to S^{N} a comparison result R_{m,j}ⁿ related to a difference ΔOC_{m,j} between observation components, a maximum score Ω_{m, MAX}, and a threshold set S_{m, MAX}.

FIG. 11 is a configuration diagram illustrating an observation device according to Embodiment 2.

FIG. 12 is a hardware configuration diagram illustrating hardware of the observation device according to Embodiment 2.

FIG. 13 is an explanatory view illustrating a comparison result extracted by a score calculation unit 7a, and a score Ωⁿ (n=1, . . . , and N) of the threshold set Sⁿ that is based on the extracted comparison result.

### DESCRIPTION OF EMBODIMENTS

Hereinafter, a mode for carrying out the present disclosure will be described with reference to the accompanying drawings to describe the present disclosure in more detail.

### Embodiment 1

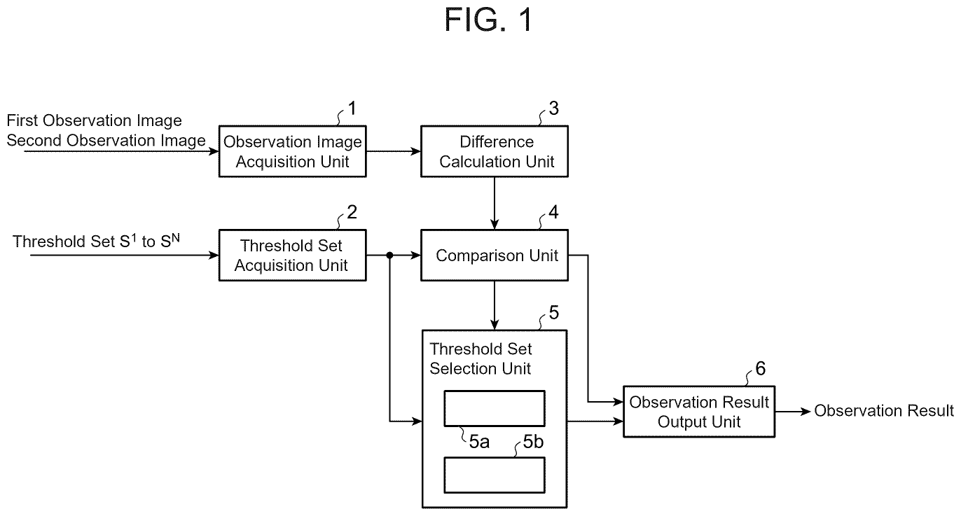

FIG. 1 is a configuration diagram illustrating an observation device according to Embodiment 1.

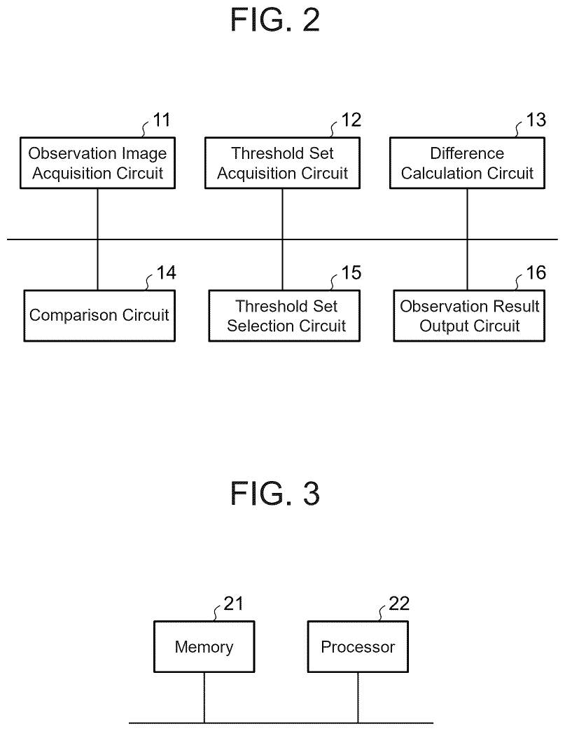

FIG. 2 is a hardware configuration diagram illustrating hardware of the observation device according to Embodiment 1.

The observation device illustrated in FIG. 1 includes an observation image acquisition unit 1, a threshold set acquisition unit 2, a difference calculation unit 3, a comparison unit 4, a threshold set selection unit 5, and an observation result output unit 6.

The observation image acquisition unit 1 is implemented by, for example, an observation image acquisition circuit 11 illustrated in FIG. 2.

The observation image acquisition unit 1 acquires a first observation image that is an image obtained by capturing an observation target region, and a second observation image that is an image obtained by capturing the observation target region at a time different from that of the first observation image.

The observation image acquisition unit 1 outputs each of the first observation image and the second observation image to the difference calculation unit 3.

The first observation image is, for example, an image obtained before an event occurs in the observation target region. Examples of the event include an earthquake or a flood. The first observation image is desirably an image at a time when an abnormality accompanying an event does not occur. Hence, the first observation image may be an image obtained after an event has occurred and the situation has returned to a normal state as a result of recovery.

The second observation image is, for example, an image obtained after an event occurs in the observation target region. The second observation image is not limited to one image, and may be M observation target images whose capturing times are respectively different from each other. M represents an integer equal to or more than one.

The threshold set acquisition unit 2 is implemented by, for example, a threshold set acquisition circuit 12 illustrated in FIG. 2.

The threshold set acquisition unit 2 acquires N threshold sets which are different from each other. Each threshold set includes thresholds related to one or more types of observation components included in both of the first observation image and the M observation target images that are the second observation images. N represents an integer equal to or more than two.

The threshold set acquisition unit 2 outputs the N threshold sets to each of the comparison unit 4 and the threshold set selection unit 5.

The difference calculation unit 3 is implemented by, for example, a difference calculation circuit 13 illustrated in FIG. 2.

The difference calculation unit 3 acquires each of the first observation image and the second observation image from the observation image acquisition unit 1.

The difference calculation unit 3 calculates a difference between each of observation components included in the first observation image and each of observation components included in the second observation image.

More specifically, the difference calculation unit 3 calculates the difference between each of the observation components included in the first observation image and each of the observation components included in each of the observation target images.

The difference calculation unit 3 outputs the difference between the observation components to the comparison unit 4.

The comparison unit 4 is implemented by, for example, a comparison circuit 14 illustrated in FIG. 2.

The comparison unit 4 acquires the N threshold sets from the threshold set acquisition unit 2, and acquires the difference between the observation components from the difference calculation unit 3.

The comparison unit 4 compares the difference between the observation components, with the threshold included in each of the threshold sets and related to each of the observation components.

The comparison unit 4 outputs a comparison result of the difference between the observation components with the threshold to each of the threshold set selection unit 5 and the observation result output unit 6.

The threshold set selection unit 5 is implemented by, for example, a threshold set selection circuit 15 illustrated in FIG. 2.

The threshold set selection unit 5 includes a score calculation unit 5a and a threshold set selection processing unit 5b.

The threshold set selection unit 5 acquires the N threshold sets from the threshold set acquisition unit 2, and acquires the comparison result of the difference between the observation components with the threshold from the comparison unit 4.

The threshold set selection unit 5 selects a certain threshold set from the N threshold sets on the basis of comparison results of the comparison unit 4.

The threshold set selection unit 5 outputs the selected threshold set to the observation result output unit 6.

The score calculation unit 5a calculates a score of each of the threshold sets as an index for determining a degree of excellence of each of the N threshold sets on the basis of the comparison results of the comparison unit 4.

More specifically, the score calculation unit 5a acquires, from the outside, local information that is information indicating whether or not an abnormality is occurring in the observation target region. The local information is acquired via, for example, a Social Networking Service (SNS) or Internet of Things (IoT). The score calculation unit 5a determines whether or not a comparison result from the comparison unit 4 is correct by cross-checking the local information and the comparison result. The score calculation unit 5a calculates a score of each of the threshold sets using a cross-check result indicating whether or not the comparison result is correct.

The score calculation unit 5a outputs the score of each of the threshold sets to the threshold set selection processing unit 5b.

The threshold set selection processing unit 5b acquires the score of each of the threshold sets from the score calculation unit 5a.

The threshold set selection processing unit 5b compares N scores calculated by the score calculation unit 5a, and selects a certain threshold set from the N threshold sets on the basis of a comparison result of the scores.

The threshold set selection processing unit 5b outputs the selected threshold set to the observation result output unit 6.

The observation result output unit 6 is implemented by, for example, an observation result output circuit 16 illustrated in FIG. 2.

The observation result output unit 6 acquires the comparison result of the difference between the observation components with the threshold from the comparison unit 4, and acquires the threshold set from the threshold set selection unit 5.

The observation result output unit 6 extracts the result of comparison for which the threshold included in the threshold set selected by the threshold set selection unit 5 has been used from comparison results of the comparison unit 4.

The observation result output unit 6 outputs the extracted comparison result as an observation result to, for example, an unillustrated display device.

FIG. 1 assumes that each of the observation image acquisition unit 1, the threshold set acquisition unit 2, the difference calculation unit 3, the comparison unit 4, the threshold set selection unit 5, and the observation result output unit 6 that are components of the observation device is implemented by dedicated hardware illustrated in FIG. 2. That is, it is assumed that the observation device is implemented by an observation image acquisition circuit 11, a threshold set acquisition circuit 12, a difference calculation circuit 13, a comparison circuit 14, a threshold set selection circuit 15, and an observation result output circuit 16.

Each of the observation image acquisition circuit 11, the threshold set acquisition circuit 12, the difference calculation circuit 13, the comparison circuit 14, the threshold set selection circuit 15, and the observation result output circuit 16 corresponds to, for example, a single circuit, a composite circuit, a programmed processor, a parallel-programmed processor, an Application Specific Integrated Circuit (ASIC), a Field-Programmable Gate Array (FPGA), or a combination thereof.

The components of the observation device are not limited to components that are implemented by dedicated hardware, and the observation device may be implemented by software, firmware, or a combination of software and firmware.

The software or the firmware is stored as programs in a memory of a computer. The computer means hardware that executes the programs, and may correspond to, for example, a Central Processing Unit (CPU), a Graphics Processing Unit (GPU), a center processing device, a processing device, an arithmetic operation device, a microprocessor, a microcomputer, a processor, or a Digital Signal Processor (DSP).

FIG. 3 is a hardware configuration diagram of a computer in a case where the observation device is implemented by software, firmware, or the like.

In a case where the observation device is implemented by software, firmware, or the like, programs for causing the computer to execute respective processing procedures performed in the observation image acquisition unit 1, the threshold set acquisition unit 2, the difference calculation unit 3, the comparison unit 4, the threshold set selection unit 5, and the observation result output unit 6 are stored in a memory 21. Furthermore, a processor 22 of the computer executes the programs stored in the memory 21.

Furthermore, FIG. 2 illustrates an example where each of the components of the observation device is implemented by dedicated hardware, and FIG. 3 illustrates an example where the observation device is implemented by software, firmware, or the like. However, this is merely an example, and part of the components of the observation device may be implemented by dedicated hardware, and the rest of the components may be implemented by software, firmware, or the like.

Next, an operation of the observation device illustrated in FIG. 1 will be described.

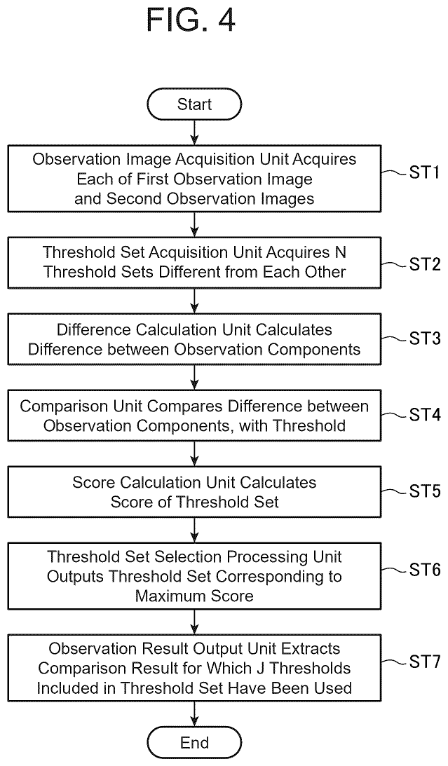

FIG. 4 is a flowchart illustrating an observation method that is a processing procedure performed in the observation device.

The observation image acquisition unit 1 acquires a first observation image G₁ obtained at an observation time to as the image obtained by capturing the observation target region (step ST1 in FIG. 4).

Furthermore, the observation image acquisition unit 1 acquires an observation target image G_{2, m} obtained at an observation time tₘ as a second observation image G₂ (step ST1 in FIG. 4). m=1, . . . , and M holds.

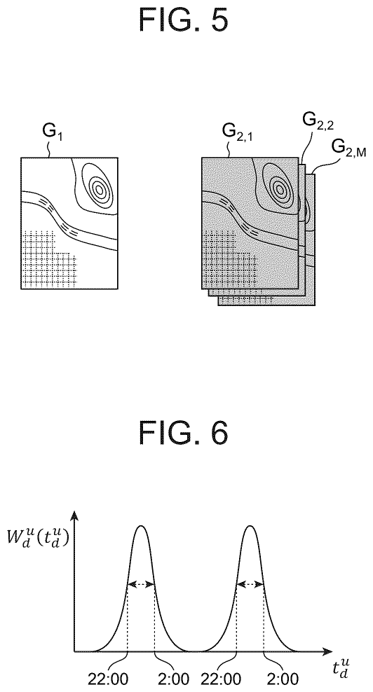

FIG. 5 is an explanatory view illustrating each of the first observation image G₁ and the observation target image G_{2, m}.

The observation image acquisition unit 1 outputs each of the first observation image G₁ and the observation target image G_{2, m} to the difference calculation unit 3.

The threshold set acquisition unit 2 acquires N threshold sets S¹ to S^{N} which are different from each other. Each threshold set includes thresholds Thⱼ related to one or more types of observation components OCⱼ included in the first observation image G₁ and in each of M observation target images G_{2, 1} to G_{2, M} (step ST2 in FIG. 4). N represents an integer equal to or more than one, and j=1, . . . , and J holds. J represents an integer equal to or more than one.

Examples of the one or more types of observation components OCⱼ included in the first observation image G₁ or the like include a brightness component, a chromaticity component, or a hue component.

The threshold set Sⁿ (n=1, . . . , and N) includes J thresholds Th₁ⁿ to Th_{J}ⁿ as expressed in the equation (1).

$$\begin{matrix}{S}^{1} = {Th}_{1}^{1} , … , and {Th}_{J}^{1} \\ {S}^{2} = {Th}_{1}^{2} , … , and {Th}_{J}^{2} \\ ⋮ \\ {S}^{N} = {Th}_{1}^{N} , … , and {Th}_{J}^{N}\end{matrix} \qquad ( 1 )$$

The threshold set acquisition unit 2 outputs the N threshold sets S¹ to S^{N} to each of the comparison unit 4 and the threshold set selection unit 5.

The difference calculation unit 3 acquires the first observation image G₁ and each of the M second observation images G_{2, 1} to G_{2, M} from the observation image acquisition unit 1.

As expressed in the following equation (2), the difference calculation unit 3 calculates a difference ΔOC_{m, j} (m=1, . . . , and M; j=1, . . . , and J) between an observation component OC(1)ⱼ (j=1, . . . , and J) included in the first observation image G₁ and an observation component OC(2)_{m, j} included in the observation target image G_{2, m} (m=1, . . . , and M) (step ST3 in FIG. 4). OC(1)ⱼ and OC(2)_{m, j} represent observation components of the same type, and mean that, as the difference ΔOC_{m, j} between the observation component is greater, a change in the observation target region is greater.

$$Δ {OC}_{m , j} = \vert {OC ( 1 )}_{j} - {OC ( 2 )}_{m , j} \vert \qquad ( 2 )$$

The difference calculation unit 3 outputs the difference ΔOC_{m, j} between the observation components to the comparison unit 4.

The comparison unit 4 acquires the N threshold sets S¹ to S^{N} from the threshold set acquisition unit 2, and acquires the difference ΔOC_{m, j} (m=1, . . . , and M; j=1, . . . and J) between the observation components from the difference calculation unit 3.

The comparison unit 4 compares the difference ΔOC_{m, j} between the observation components, with a threshold Thⱼⁿ (j=1, . . . , and J; n=1, . . . , and N) included in the threshold set Sⁿ (n=1, . . . , and N) (step ST4 in FIG. 4).

When the difference ΔOC_{m,j} between the observation components is equal to or greater than the threshold Thⱼⁿ, a change in the observation target region is large and, for example, a flood is highly likely to have occurred in the observation target region. On the other hand, when the difference ΔOC_{m,j} between the observation components is less than the threshold Thⱼⁿ, the change in the observation target region is small and, for example, a flood is less likely to have occurred in the observation target region.

The comparison unit 4 outputs a comparison result R_{m,j}ⁿ (m=1, . . . , and M; j=1, . . . and, J; n=1, . . . , and N) of the difference ΔOC_{m, j} between the observation components and the threshold Thⱼⁿ to each of the threshold set selection unit 5 and the observation result output unit 6.

The score calculation unit 5a of the threshold set selection unit 5 acquires the N threshold sets S¹ to S^{N} from the threshold set acquisition unit 2, and acquires from the comparison unit 4 the comparison result R_{m,j}ⁿ (m=1, . . . , and M; j=1, . . . , and J; n=1, . . . , and N) related to the difference ΔOC_{m, j} between the observation components included in the observation target image G_{2, m} (m=1, . . . , and M).

As expressed in the following equation (3), the score calculation unit 5a calculates a score Ωₘⁿ (m=1, . . . , M; n=1, . . . , and N) of the threshold set Sⁿ (n=1, . . . , and N) as an index for determining a degree of excellence of the N threshold sets S₁ to SN on the basis of the comparison result R_{m,j}ⁿ related to the difference ΔOC_{m,j} between the observation components (step ST5 in FIG. 4).

The score calculation unit 5a outputs the score Ωₘⁿ of the threshold set Sⁿ to the threshold set selection processing unit 5b.

$${Ω}_{m}^{n} = 100 \times \frac{1}{{K}_{d}} {\sum }_{k = 1}^{{K}_{d}} {W}_{d}^{u} ( {t}_{d}^{u} ) {W}_{k}^{l} ( 1 - \frac{{dt}_{k}^{l}}{{W}_{m}} ) {J}_{m , n}^{j} \qquad ( 3 )$$

In the equation (3), W_{d}^{u}(t_{d}^{u}) represents a weight coefficient that changes as time passes as illustrated in FIG. 6. In an example in FIG. 6, a weight coefficient W_{d}^{u}(t_{d}^{u}) is maximum when a time t_{d}^{u} is around 24 o'clock, and the weight coefficient W_{d}^{u}(t_{d}^{u}) is minimum when the time t_{d}^{u} is around 12 o'clock. FIG. 6 is an explanatory view illustrating an example of a weight coefficient W_{d}^{t} (t_{d}^{u}) that changes as time passes.

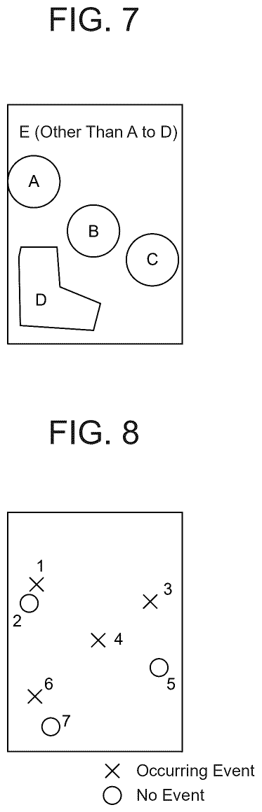

FIG. 7 is an explanatory view illustrating an example of a region for which the degree of importance has been set by a user.

In FIG. 7, A, B, C, D, and E each are regions to which the degrees of importance have been set by the user, and the weight coefficient W_{d}^{u} (φ_{d}^{u}, λ_{d}^{u}, and t_{d}^{u}) are weight coefficients of the region A, B, C, D, or E. The subscript d of the weight coefficient W_{d}^{u} (φ_{d}^{u}, λ_{d}^{u}, and t_{d}^{u}) means d=A, B, C, D, or E.

(φ_{d}^{u} and λ_{d}^{u}) represent a latitude of a region d and a longitude of the region d, respectively. t_{d}^{u} represents a time of interest of the user.

Wₖ¹ represents, for example, a weight coefficient obtained via an SNS or IoT and corresponding to local information as illustrated in FIG. 8.

FIG. 8 is an explanatory view illustrating an example of local information indicating whether or not an abnormality occurs in an observation target region.

In the example in FIG. 8, ∘ represents information of no event indicating a situation that a disaster is not occurring at a certain spot, and is, for example, Wₖ¹=0.3. x represents information of an occurring event indicating a situation that a disaster is occurring at a certain spot, and is, for example, Wₖ¹=0.8. In FIG. 8, numbers 1 to 7 are numbers for identifying certain spots.

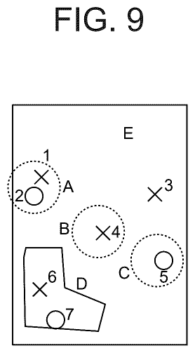

FIG. 9 is an explanatory view obtained by overlaying FIGS. 7 and 8. The region A includes spots 1 and 2, and K_{d}=2 holds. The region B includes a spot 4, and K_{d}=1 holds. The region C includes a spot 5, and K_{d}=1 holds. The region D includes spots 6 and 7, and K_{d}=2 holds.

As expressed in the following equation (4), dtₖ¹ represents a time difference between the observation time tₘ of the observation target image G_{2, m} and a time tₖ¹ at which the local information has been obtained.

$${dt}_{k}^{1} = {t}_{m} - {t}_{k}^{1} \qquad ( 4 )$$

Wₘ represents a weight coefficient of the observation time tₘ.

J_{m, j}ⁿ represents a cross-check result of the local information and the comparison result R_{m,j}ⁿ. When the local information and the comparison result R_{m,j}ⁿ match and the comparison result R_{m, j}ⁿ is correct, J_{m, j}ⁿ is “1”. When the local information and the comparison result R_{m, j}ⁿ do not match and the comparison result R_{m, j}ⁿ is not correct, J_{m, j}ⁿ is “0”.

When, for example, the comparison result R_{m, j}ⁿ corresponding to the spot 1 is the threshold Thⱼⁿ or more, the local information at the spot 1 is “x”, and therefore J_{m,j}ⁿ is “1”. On the other hand, when the comparison result R_{m, j}ⁿ corresponding to the spot 1 is less than the threshold Thⱼⁿ, the local information at the spot 1 is “x”, and therefore J_{m,j}ⁿ is “0”.

When, for example, the comparison result R_{m, j}ⁿ corresponding to the spot 2 is the threshold Thⱼⁿ or more, the local information at the spot 1 is “∘”, and therefore J_{m,j}ⁿ is “0”. On the other hand, when the comparison result R_{m, j}ⁿ corresponding to the spot 2 is less than the threshold Thⱼⁿ, the local information at the spot 2 is “∘”, and therefore J_{m,j}ⁿ is “1”.

In the equation (3), when (1−dtₖ¹/Wₘ)J_{m, j}ⁿ is a negative value, the value is replaced with 0.

The score calculation unit 5a calculates the score Ωₘⁿ of the threshold set Sⁿ using the cross-check result j_{m,j}ⁿ indicating whether or not the comparison result R_{m,j}ⁿ is correct as described above. Hence, the score Ωₘⁿ of the threshold set Sⁿ is an index indicating whether or not the threshold Thⱼⁿ (j=1, . . . , and J; n=1, . . . , and N) included in the threshold set Sⁿ is an appropriate value.

The threshold set selection processing unit 5b acquires the score Ωₘⁿ (m=1, . . . and M; n=1, . . . , and N) of the threshold set Sⁿ (n=1, . . . , and N) from the score calculation unit 5a.

The threshold set selection processing unit 5b compares N scores Ωₘ¹ to Ωₘⁿ for each of the M observation target image G_{2, 1} to G_{2, M}.

That is, in a case where, for example, the observation target image is G_{2, 1}, the threshold set selection processing unit 5b compares N scores Ω₁¹ to Ω₁ⁿ for the observation target image G_{2, 1}.

In a case where, for example, the observation target image is G_{2, M}, the threshold set selection processing unit 5b compares N scores Ω_{M}¹ to Ω_{M}^{N} for the observation target image G_{2, M}.

The threshold set selection processing unit 5b selects a maximum score Ω_{m, MAX} from the N scores Ωₘ¹ to Ωₘ^{N} as expressed in the following equation (5) on the basis of the comparison result of the N scores Ωₘ¹ to Ωₘ^{N}.

$${Ω}_{m , MAX} = {max {Ω}_{m}^{n}}_{{S}^{n}} \qquad ( 5 )$$

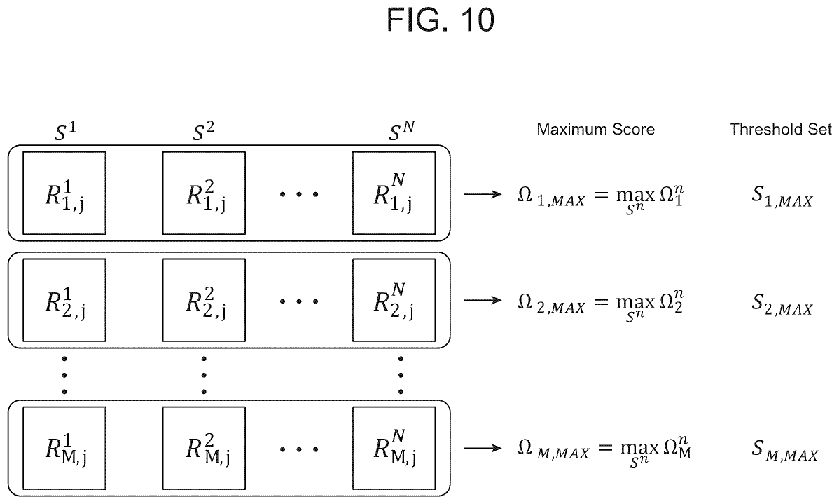

FIG. 10 is an explanatory view illustrating the N threshold sets S¹ to S^{N}, the comparison result R_{m, j}ⁿ related to the difference ΔOC_{m, j} between observation components, the maximum score Ω_{m, MAX}, and the threshold set S_{m, MAX}.

The threshold set S_{m, MAX} corresponding to the maximum score Ωm, MAX (m=1, . . . , and M) among the N threshold sets S¹ to S^{N} is highly likely to be the threshold set most suitable to the observation target image G_{2, m} (m=1, . . . , and M).

The threshold set selection processing unit 5b outputs the threshold set S_{m, MAX} corresponding to the maximum score Ω_{m, MAX} to the observation result output unit 6 (step ST6 in FIG. 4).

In the observation device illustrated in FIG. 1, the threshold set selection processing unit 5b outputs the threshold set S_{m, MAX} corresponding to the maximum score Ω_{m, MAX} to the observation result output unit 6. However, it is sufficient that the threshold set can be optimized, and the threshold set to be output to the observation result output unit 6 is not limited to the threshold set S_{m, MAX} corresponding to the maximum score Ω_{m, MAX}. Hence, the threshold set selection processing unit 5b may output, for example, the threshold set corresponding to the second largest score among the N scores Ω_{m, 1} to Ω_{m, N} to the observation result output unit 6 if there is no practical problem.

The observation result output unit 6 acquires the comparison result R_{m,j}ⁿ (m=1, . . . , and M; j=1, . . . , and J; n=1, . . . , and N) from the comparison unit 4, and acquires a threshold set S_{MAX} from the threshold set selection unit 5.

The observation result output unit 6 extracts a comparison result for which the J thresholds Th₁ⁿ to Th_{J}ⁿ included in the threshold set S_{m, MAX} have been used from the comparison results R_{m,j}ⁿ (m=1, . . . , and M; j=1, . . . , and J; n=1, . . . , and N) (step ST7 in FIG. 4).

When, for example, the threshold set S_{m, MAX} is the threshold set S³, the observation result output unit 6 extracts a comparison result R_{m, j}³ for which the J thresholds Th₁³ to Th_{J}³ included in the threshold set S³ have been used from the comparison results R_{m, j}ⁿ (m=1, . . . , and M; j=1, . . . , and J; n=1, . . . , and N).

When, for example, the threshold set S_{m, MAX} is the threshold set S⁴, the observation result output unit 6 extracts a comparison result R_{m, j}⁴ for which the J thresholds Th₁⁴ to Th_{J}⁴ included in the threshold set S⁴ have been used from the comparison results R_{m, j}ⁿ (m=1, . . . , and M; j=1, . . . , and J; n=1, . . . , and N).

The observation result output unit 6 outputs the extracted comparison result as an observation result to, for example, an unillustrated display device.

According to above Embodiment 1, the observation device includes the threshold set acquisition unit 2 that acquires the respectively different N (N represents the integer equal to or more than two) threshold sets as threshold sets each including the thresholds related to one or more types of observation components included in both of the first observation image that is the image obtained by capturing the observation target region and the second observation image that is the image obtained by capturing the observation target region at the time different from that of the first observation image, and the difference calculation unit 3 that calculates a difference between each of the observation components included in the first observation image and each of the observation components included in the second observation image. Furthermore, the observation device includes the comparison unit 4 that compares the difference between the observation components calculated by the difference calculation unit 3, with the threshold included in each of the threshold sets acquired by the threshold set acquisition unit 2 and related to each of the observation components, and the threshold set selection unit 5 that selects a certain threshold set from the N threshold sets acquired by the threshold set acquisition unit 2 on the basis of a comparison result of the comparison unit 4. Accordingly, it is possible to increase detection accuracy of a change in an observation target region compared to the observation device disclosed in Patent Literature 1.

### Embodiment 2

Embodiment 2 will describe an observation device in which the threshold set selection unit 7 includes a score calculation unit 7a and a threshold set selection processing unit 7b.

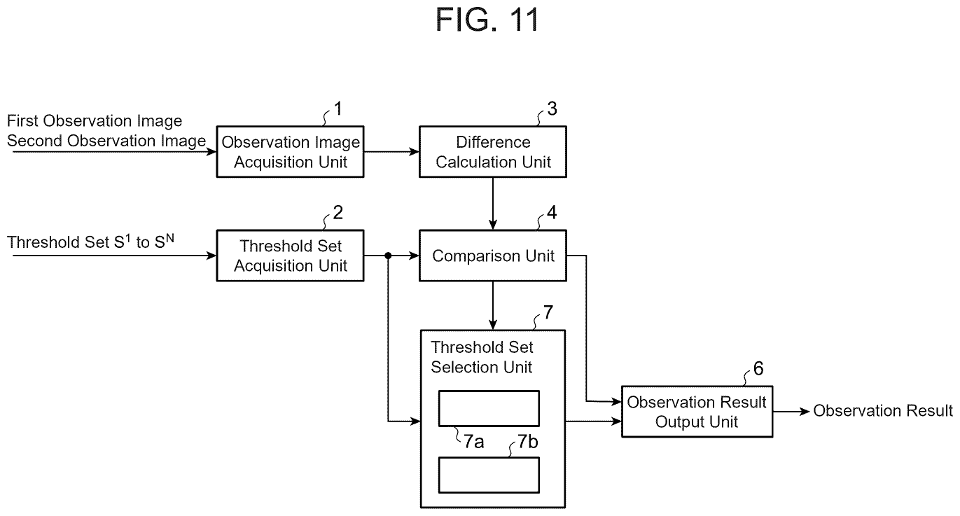

FIG. 11 is a configuration diagram illustrating the observation device according to Embodiment 2. Note that, in FIG. 11, the same reference numerals as those in FIG. 1 indicate identical or corresponding parts, and therefore detailed description thereof will be omitted.

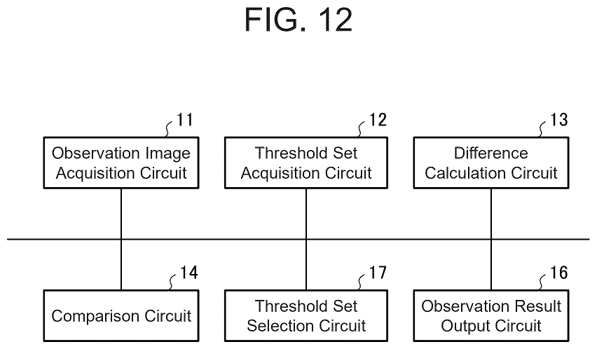

FIG. 12 is a hardware configuration diagram illustrating hardware of the observation device according to Embodiment 2. Note that, in FIG. 12, the same reference numerals as those in FIG. 2 indicate identical or corresponding parts, and therefore detailed description thereof will be omitted.

The observation device illustrated in FIG. 11 includes the observation image acquisition unit 1, the threshold set acquisition unit 2, the difference calculation unit 3, the comparison unit 4, the threshold set selection unit 7, and the observation result output unit 6.

The threshold set selection unit 7 is implemented by, for example, a threshold set selection circuit 17 illustrated in FIG. 12.

The threshold set selection unit 7 includes a score calculation unit 7a and a threshold set selection processing unit 7b.

The threshold set selection unit 7 acquires the N threshold sets from the threshold set acquisition unit 2, and acquires the comparison result of the difference between the observation components with the threshold from the comparison unit 4.

The threshold set selection unit 7 selects a certain threshold set from the N threshold sets on the basis of comparison results of the comparison unit 4.

The threshold set selection unit 7 outputs the selected threshold set to the observation result output unit 6.

The score calculation unit 7a acquires the comparison result R_{m,j}ⁿ (m=1, . . . , and M; j=1, . . . , and J; n=1, . . . , and N) from the comparison unit 4.

The score calculation unit 7a extracts a comparison result for which each threshold set Sⁿ (n=1, . . . , and N) has been used from the comparison results R_{m, j}ⁿ (m=1, . . . , and M; j=1, . . . , and J; n=1, . . . , and N).

The score calculation unit 7a calculates a score Ωⁿ (n=1, . . . , and N) of each of the threshold sets Sⁿ on the basis of the extracted comparison result.

The score calculation unit 7a outputs the score Ωⁿ (n=1, . . . , and N) of the threshold set Sⁿ to the threshold set selection processing unit 7b.

The threshold set selection processing unit 7b acquires the score Ωⁿ (n=1, . . . and N) of the threshold set Sⁿ from the score calculation unit 7a.

The threshold set selection processing unit 7b compares N scores Ω¹ to Ω^{N}, and selects a certain threshold set from the N threshold sets S¹ to S^{N} on the basis of a comparison result of the scores Ω¹ to Ω_{N}.

The threshold set selection processing unit 7b outputs the selected threshold set to the observation result output unit 6.

FIG. 11 assumes that each of the observation image acquisition unit 1, the threshold set acquisition unit 2, the difference calculation unit 3, the comparison unit 4, the threshold set selection unit 7, and the observation result output unit 6 that are components of the observation device is implemented by dedicated hardware illustrated in FIG. 12. That is, it is assumed that the observation device is implemented by the observation image acquisition circuit 11, the threshold set acquisition circuit 12, the difference calculation circuit 13, the comparison circuit 14, the threshold set selection circuit 17, and the observation result output circuit 16.

Each of the observation image acquisition circuit 11, the threshold set acquisition circuit 12, the difference calculation circuit 13, the comparison circuit 14, the threshold set selection circuit 17, and the observation result output circuit 16 corresponds to, for example, a single circuit, a composite circuit, a programmed processor, a parallel-programmed processor, an ASIC, an FPGA, or a combination thereof.

The components of the observation device are not limited to components that are implemented by dedicated hardware, and the observation device may be implemented by software, firmware, or a combination of software and firmware.

In a case where the observation device is implemented by software, firmware, or the like, programs for causing the computer to execute respective processing procedures performed in the observation image acquisition unit 1, the threshold set acquisition unit 2, the difference calculation unit 3, the comparison unit 4, the threshold set selection unit 7, and the observation result output unit 6 are stored in the memory 21 in FIG. 3. Furthermore, the processor 22 illustrated in FIG. 3 executes the programs stored in the memory 21.

Furthermore, FIG. 12 illustrates an example where each of the components of the observation device is implemented by dedicated hardware, and FIG. 3 illustrates an example where the observation device is implemented by software, firmware, or the like. However, this is merely an example, and part of the components of the observation device may be implemented by dedicated hardware, and the rest of the components may be implemented by software, firmware, or the like.

Next, an operation of the observation device illustrated in FIG. 11 will be described. In this regard, the components other than the score calculation unit 7a and the threshold set selection processing unit 7b are the same as those of the observation device illustrated in FIG. 1. Hence, only operations of the score calculation unit 7a and the threshold set selection processing unit 7b will be described hereinafter.

The score calculation unit 7a acquires the comparison result R_{m,j}ⁿ (m=1, . . . , and M; j=1, . . . , and J; n=1, . . . , and N) from the comparison unit 4.

The score calculation unit 7a extracts a comparison result for which each of the threshold sets Sⁿ (n=1, . . . , and N) has been used from the comparison result R_{m,j}ⁿ (m=1, . . . , and M; j=1, . . . , and J; n=1, . . . , and N).

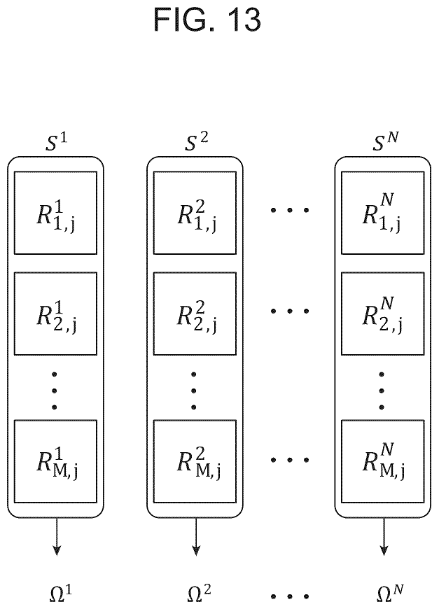

As illustrated in FIG. 13, the comparison result extracted by the score calculation unit 7a is a comparison result for which each of the threshold sets Sⁿ (n=1, . . . , and N) has been used among comparison results related to J observation components OC(2)_{m, j} (m=1, . . . , and M; j=1, . . . , and J) included in each of the M observation target images G_{2, 1} to G_{2, M}.

FIG. 13 illustrates an example where comparison results R_{1, j}¹ to R_{M, j}¹ for which the threshold set S¹ has been used, comparison results R_{1, j}² to R_{M,j}² for which the threshold set S² has been used, and comparison results R_{1, j}^{N} to R_{M, j}^{N} for which the threshold set S^{N} has been used are extracted.

FIG. 13 is an explanatory view illustrating a comparison result extracted by the score calculation unit 7a, and the score Ωⁿ (n=1, . . . , and N) of the threshold set Sⁿ that is based on the extracted comparison result.

As expressed in the following equation (6), the score calculation unit 7a calculates the score Ωⁿ (n=1, . . . , and N) of each of the threshold sets Sⁿ on the basis of the extracted comparison result.

The score calculation unit 7a outputs the score Ωⁿ (n=1, . . . , and N) of the threshold set Sⁿ to the threshold set selection processing unit 7b.

$${Ω}^{n} = \frac{1}{M} {\sum }_{m = 1}^{M} {Ω}_{m}^{n} \qquad ( 6 )$$

The threshold set selection processing unit 7b acquires the score Ωⁿ (n=1, . . . and N) of the threshold set Sⁿ from the score calculation unit 7a.

The threshold set selection processing unit 7b compares the N scores Ω¹ to Ωⁿ, and selects a maximum score Ω_{MAX} among the N scores Ω¹ to Ωⁿ as expressed in the following equation (7).

The threshold set selection processing unit 7b outputs the threshold set S_{m, MAX} corresponding to the maximum score Ω_{MAX} among the N threshold sets S¹ to S^{N} to the observation result output unit 6.

$${Ω}_{M A X} = {max}_{{S}^{n}} {Ω}_{j} \qquad ( 7 )$$

In the observation device illustrated in FIG. 11, the threshold set selection processing unit 7b outputs the threshold set S_{MAX} corresponding to the maximum score Ω_{MAX} to the observation result output unit 6. However, it is possible that the threshold set can be optimized, and the threshold set to be output to the observation result output unit 6 is not limited to the threshold set S_{MAX} corresponding to the maximum score Ω_{MAX}. Hence, the threshold set selection processing unit 7b may output, for example, the threshold set corresponding to the second largest score among the N scores Ω¹ to Ω^{N} to the observation result output unit 6 if there is no practical problem.

According to above Embodiment 2, the observation device is configured in such a way that the threshold set selection unit 7 includes the score calculation unit 7a that extracts from the comparison result of the comparison unit 4 a comparison result for which each of the threshold sets acquired by the threshold set acquisition unit 2 has been used, and calculates a score of each of the threshold sets on the basis of the extracted comparison result, and the threshold set selection processing unit 7b that compares a plurality of scores calculated by the score calculation unit 7a, and selects a certain threshold set from the N threshold sets acquired by the threshold set acquisition unit 2 on the basis of a comparison result of the scores. Accordingly, it is possible to increase detection accuracy of a change in an observation target region compared to the observation device disclosed in Patent Literature 1.

Note that the present disclosure allows free combinations of the embodiments, modification of arbitrary components in the embodiments, or omission of arbitrary components in the embodiments.

### INDUSTRIAL APPLICABILITY

The present disclosure is suitable to an observation device and an observation method.

### REFERENCE SIGNS LIST

1: observation image acquisition unit, 2: threshold set acquisition unit, 3: difference calculation unit, 4: comparison unit, 5: threshold set selection unit, 5a: score calculation unit, 5b: threshold set selection processing unit, 6: observation result output unit, 7: threshold set selection unit, 7a: score calculation unit, 7b: threshold set selection processing unit, 11: observation image acquisition circuit, 12: threshold set acquisition circuit, 13: difference calculation circuit, 14: comparison circuit, 15: threshold set selection circuit, 16: observation result output circuit, 17: threshold set selection circuit, 21: memory, 22: processor

1. An observation device comprising processing circuitry
to acquire N (N represents an integer equal to or more than two) threshold sets, which are different from each other, as threshold sets each including thresholds related to at least one type of observation component included in both of a first observation image that is obtained by capturing an observation target region and a second observation image that is obtained by capturing the observation target region at a time different from a time of the first observation image,
to calculate differences between the observation components included in the first observation image and the observation components included in the second observation image, respectively,
to perform, respectively, comparison of the differences of the observation components, and the thresholds included in the threshold sets and respectively related to the observation components and
to select a certain threshold set from the N threshold sets on a basis of a result of the comparison.

2. The observation device according to claim 1, wherein the processing circuitry is further configured to extract a comparison result for which a threshold included in the certain threshold set has been used from the result of the comparison, and output the comparison result extracted as an observation result.

3. The observation device according to claim 1, wherein the processing circuitry is further configured
to calculate scores of the threshold sets, respectively, as an index for determining a degree of excellence of each of the N threshold sets on the basis of the result of the comparison, and
to perform comparison of the scores whose number is N with each other, and select a certain threshold set from the N threshold sets on a basis of a result of the comparison of the scores.

4. The observation device according to claim 3, wherein the processing circuitry acquires, from an outside, local information that indicates whether or not an abnormality occurs in the observation target region, perform cross-checking of the local information with the result of the comparison, and calculate the score of each of the threshold sets using a result of the cross-checking.

5. The observation device according to claim 1, wherein
as the second observation images, there are M (M represents an integer equal to or more than one) observation target images whose capturing times are different from each other,
the processing circuitry calculates differences between the observation components included in the first observation image and the observation components included in the observation images, respectively, and
performs, respectively, comparison of the differences of the observation components, and the thresholds included in the N threshold sets and related to each of the observation components.

6. The observation device according to claim 5, wherein the processing circuitry is further configured
to calculate scores of the threshold sets, respectively, as an index for determining a degree of excellence of each of the N threshold sets on the basis of the result of the comparison, and
to perform comparison of the scores whose number is N with each other, and select a certain threshold set from the N threshold sets on a basis of a result of the comparison of the scores.

7. The observation device according to claim 5, wherein the processing circuitry is further configured
to extract, from results of the comparison, comparison results for which the threshold sets has been used, respectively, and calculate scores of the threshold sets on a basis of the comparison results extracted, and
to perform comparison of the scores with each other, and select a certain threshold set from the N threshold sets on a basis of a result of the comparison of the score.

8. An observation method comprising:
acquiring N (N represents an integer equal to or more than two) threshold sets, which are different from each other, as threshold sets each including thresholds related to at least one type of observation component included in both of a first observation image that is obtained by capturing an observation target region and a second observation image that is obtained by capturing the observation target region at a time different from a time of the first observation image;
calculating differences between the observation components included in the first observation image and the observation components included in the second observation image, respectively;
performing comparison of the differences of the observation components, and the thresholds included in the threshold sets and respectively related to the observation components; and
selecting a certain threshold set from the N threshold sets on a basis of a result of the comparison.
